(19) United States
(12) Patent Application Publication
(10) Pub. No.: US 2018/0275908 A1
(43) Pub. Date: Sep. 27, 2018

(54) METHOD FOR PROVIDING SOFTWARE STACK MIGRATION

(71) Applicant: ARRIS Enterprises LLC, Suwanee, GA (US)

(72) Inventors: Walter H. Anderes, San Diego, CA (US); Fnu Premkumar, San Diego, CA (US); David L. Berger, El Cajon, CA (US)

(21) Appl. No.: 15/470,742

(22) Filed: Mar. 27, 2017

(51) Int. Cl. G06F 3/06; G06F 17/30; G06F 12/02; G06F 9/50; H04N 21/40; H04N 21/45

(52) U.S. Cl. CPC G06F 3/0644; G06F 17/30584; G06F 17/30002; G06F 12/0246; G06F 2212/72; G06F 3/0679; G06F 9/5055; H04N 21/40; H04N 21/4516; G06F 9/5061

(57) ABSTRACT

Various implementations described herein are directed to technologies for providing a software stack migration. A flash memory is provided. The flash memory includes a plurality of memory partitions. The plurality of memory partitions include at least two reserved memory partitions and a file system partition. A file system upgrade stored in one of the plurality of reserved memory partitions is provided. Partition sizes of the plurality of reserved memory partitions and the file system partition are changed in response to the provided file system upgrade.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Set top boxes are typically updated while running in the field. In some cases, platform upgrades are made to these existing set top boxes. Customers, e.g., the network operators associated with these set top boxes, expect the platform upgrades to occur seamlessly, however, there are some obstacles to seamless integration in the field. The present disclosure addresses some of these obstacles.

### SUMMARY

Described herein are implementations of various technologies of a method for providing a software stack migration. A flash memory is provided. The flash memory includes a plurality of memory partitions. The plurality of memory partitions include at least two reserved memory partitions and a file system partition. A file system upgrade stored in one of the plurality of reserved memory partitions is provided. Partition sizes of the plurality of reserved memory partitions and the file system partition are changed in response to the provided file system upgrade. The flash memory may be a NAND flash.

The file system partition may be an unsorted block images (UBI) layer partition. A boot-up script may detect whether the UBI layer partition is optimally sized. The UBI layer partition may be expanded into newly detected memory using a volume change command.

The file system upgrade can be power safe. One of the at least two reserved memory partitions may include a code image of a previous file system. This code image of the previous file system may be booted to when a power interruption occurs.

The provided file system upgrade may include a kernel and a root disk. The kernel may include a partitioning layout. The partitioning layout may be included in a partition size table. Partition sizes can be changed in accordance with the partition size table.

Partition sizes may be changed with or without destruction. Partition sizes may be changed with destruction by erasing the flash memory and booting up with the changed partition sizes. Partition sizes may be changed without destruction by erasing free space provided by the file system upgrade. The free space may be determined by determining a difference between the changed file system partition size and an original file system partition size. The free space may be added to the file system partition from the at least two reserved memory partitions. The file system partition can be expanded to include additional memory space without destroying existing data already stored in the file system partition.

Also described herein are implementations of various technologies of a device for providing a software stack migration. The device includes a set top box. The set top box may be configured to: provide a flash memory including a plurality of memory partitions, the plurality of memory partitions comprising at least two reserved memory partitions and a file system partition; provide a file system upgrade stored in one of the plurality of reserved memory partitions; and change partition sizes of the plurality of reserved memory partitions and the file system partition in response to the provided file system upgrade.

Further described herein are implementations of various technologies of a non-transitory computer-readable medium having stored thereon a plurality of computer-executable instructions which, when executed by a computer, cause the computer to: provide a flash memory including a plurality of memory partitions, the plurality of memory partitions comprising at least two reserved memory partitions and a file system partition; provide a file system upgrade stored in one of the plurality of reserved memory partitions; and change partition sizes of the plurality of reserved memory partitions and the file system partition in response to the provided file system upgrade.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates an example network environment in accordance with implementations of various techniques described herein.

FIG. 2 illustrates an example set top box in accordance with implementations of various techniques described herein.

FIG. 3 illustrates a flow diagram of a method for providing a software stack migration in accordance with implementations of various techniques described herein.

FIG. 4 illustrates a progression of a software stack migration in accordance with implementations of various techniques described herein.

FIG. 5 illustrates a progression of a software stack migration in accordance with implementations of various techniques described herein.

FIG. 6 illustrates a progression of a software stack migration in accordance with implementations of various techniques described herein.

FIG. 7 illustrates a progression of a software stack migration in accordance with implementations of various techniques described herein.

FIG. 8 illustrates a progression of a software stack migration in accordance with implementations of various techniques described herein.

FIG. 9 illustrates a progression of a software stack migration in accordance with implementations of various techniques described herein.

FIG. 10 illustrates a schematic diagram of a computing system in which the various technologies described herein may be incorporated and practiced.

### DETAILED DESCRIPTION

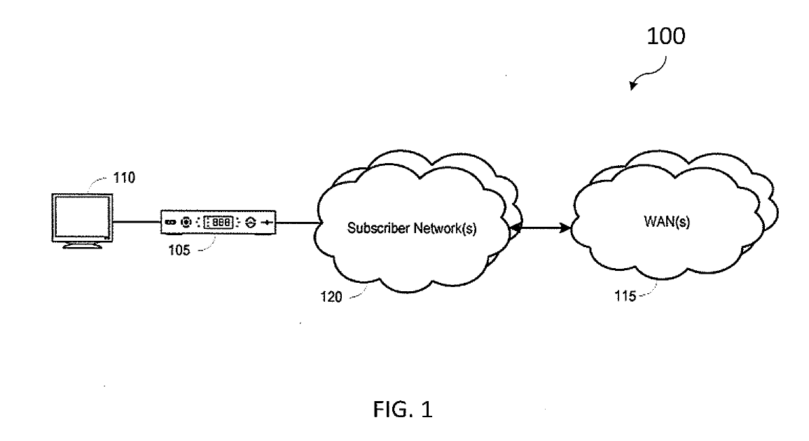

One or more implementations of various techniques for providing a software stack migration will now be described in more detail with reference to FIGS. 1-10 in the following paragraphs. The various implementations and techniques disclosed herein may be applied to a set top box or any other software upgradable device.

FIG. 1 is a block diagram illustrating an example network environment 100 for providing a software stack migration for a set top box. In some implementations, video, voice, and/or data services may be delivered to one or more client devices via one or more customer premise equipment (CPE) devices installed within a subscriber premise. For example, multiple services may be provided by a set top box (STB) 105 and may be received by a user through a display device (e.g., television 110). It should be understood that a user may receive multiple services through other display devices such as a mobile device, tablet, computer, gaming console, and others. The various data, multimedia, and/or voice services provided by the STB 105 may include, but is not limited to, live or broadcast television, video-on-demand (VoD) content, pay-per view content, recorded content (e.g., DVR content), audio-only content, streaming content, and others. A set top box (STB) may receive content from multiple different networks and/or service providers and store this content in a memory. In one implementation, STB 105 may act as a digital media server in a DLNA-based network. In one implementation, STB 105 can be a digital video recorder (DVR) or any other multimedia device capable of providing DVR-like functionality.

Multiple services may be delivered to CPE devices over one or more local networks. For example, a local network may be provided by a gateway device, and the multiple services may be delivered to one or more CPE devices by the gateway device. Local network(s) may include a coaxial network, a local area network (LAN), wireless local area network (WLAN), personal area network (PAN), Multimedia over Coax Alliance (MoCA) network, mobile hotspot network, and others. It should be understood that the STB 105 may receive services from and may output upstream communications to an access point (e.g., gateway device, modem, router, wireless extender, etc.) over a wired or wireless connection to the access point.

Multiple services may be delivered to a subscriber premise from a wide-area network (WAN) 115 through a subscriber network 120. The subscriber network 120 may include, for example, a hybrid fiber-coaxial (HFC) network, fiber network, mobile network, satellite network, and any other network operable to deliver services to a subscriber premise.

Multimedia content may be received at the STB 105 as a content stream. For example, the content may be delivered to the STB 105 as a stream of packets or frames, and the packets or frames may be decoded and processed for presentation to a user through a connected display device (e.g., television 110).

The STB 105 may be configured to receive content from a plurality of content or service providers. For example, the STB 105 may receive content and/or software upgrades from a plurality of different subscriber networks 120 (e.g., a head end of a cable network, satellite network, etc.) and/or WANs 115. Content streams received from different service providers may be received at the STB 105 in different formats.

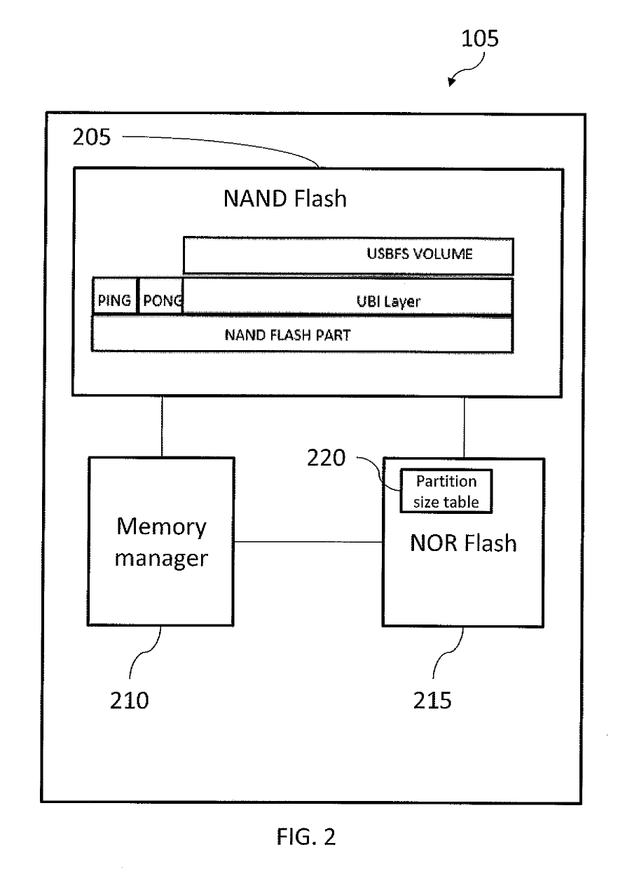

FIG. 2 is a block diagram illustrating an example STB 105 operable to add and/or change memory partitions underneath a flash memory file system and add in new memory provided by the changed and/or added partitions in accordance with various implementations described herein. Changing partition sizes of the memory partitions may include increasing and/or decreasing the sizes of each memory partition. The flash memory file system may be a software stack, which can be different middleware, file systems and/or operating systems. STB 105 seamlessly upgrades from one file system platform to another via a download of a single code object from the headend equipment 120. This seamless integration may occur without network connectivity. In other words, once the code object is downloaded, no further network connectivity is required to accomplish the upgrade. In addition, the present disclosure provides a way to upgrade from one flash file system to another in a manner that is “power safe.” An upgrade is considered power safe when a device is still able to recover if power is lost at any time during the upgrade. The STB 105 may include a NAND Flash 205, a memory manager 210, and a NOR Flash 215.

NAND Flash 205 includes an unsorted block images (UBI) layer partition, a first reserved memory partition (ping) and a second reserved memory partition (pong). NAND Flash 205 also includes a UBI file system (UBIFS) volume layer. The present disclosure uses the volume layer to provide certain information and/or benefits useful for software stack migration. The volume layer carries the original size of the file system. As such, the volume layer can be used to determine the size of the original file system and calculate the difference of the new space provided by a software stack migration. In addition, to make the software stack migration process power-safe, the software stack migration is carried out as an atomic operation. Once the file system is erased and expanded, the software stack migration process changes the volume name of the volume layer, which is an atomic operation for the UBI-FS file system. The benefit of changing the volume name is that at any point up to the atomic operation, if a power outage occurs and a reboot is needed, the system would pick up where it left off. Further, using the volume layer in this manner provides a flag to determine whether the conversion or migration is complete.

Ping and pong are reserved for code downloads, e.g., software upgrades, in the NAND flash memory 205. The rest of the NAND flash memory 205 is allocated to the flash file system, which includes the UBI and UBIFS layers.

By implementing a software upgrade from one file system type to another file system type, the partition size of the UBI layer can be increased for STB 105. This can accomplished by reducing the memory partition areas that are reserved for software upgrades and the software code image(s). In one implementation, the STB 105 utilizes the memory manager 210 and NOR Flash 215 to change the partition sizes for ping, pong, and the UBI layer. NOR flash 215 includes a partition size table 220 that is used to accomplish the change in partition sizes.

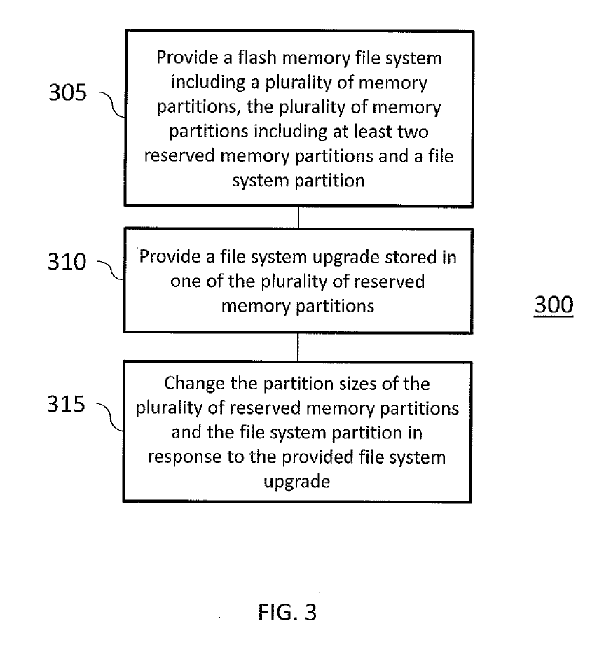

FIG. 3 illustrates a diagram of a method 300 for add and/or change memory partitions underneath a flash file system in accordance with implementations of various techniques described herein. At block 305 a flash memory including a plurality of memory partitions is provided. The plurality of memory partitions include at least two reserved memory partitions and a file system partition. In one implementation, the file system partition is an unsorted block images (UBI) layer partition.

The present disclosure is useful in upgrading a set top box from a thin client platform stack to a different media service platform. KreaTV is a media service platform provided by ARRIS, Inc. KreaTV is referred to throughout the present disclosure as the KA platform, the KA stack or the KA platform stack. Although the present disclosure describes an upgrade from thin client to KA, the present disclosure can be applied to an upgrade from any flash file system to a different flash file system and/or a migration from one software stack to another software stack in any device capable of handling these upgrades/migrations.

The upgrade can occur in a memory constrained environment, e.g., when Flash memory is at a premium. Normally, during software upgrades, code is downloaded to reserved areas of flash memory. For upgrades in a memory constrained environment, these reserved areas should be made as small as possible. The KA platform requires a lot less reserve flash area than the thin client platform. Since the reserved flash area requirements are much less, the excess reserve flash memory area can be freed up to be used for other purposes. The present disclosure thus provides a way to change the partition sizes for a device, e.g., STB 105, when upgrading from one flash file system, e.g., platform stack, to another flash file system. For example, a different flash partition layout can be used when upgrading from thin client to the KA platform because the size of the kernel code image can be greatly reduced using a memory manager 210, e.g., a device-mapper-verity (dm-verity) memory manager provided within the Linux operating system.

At block 310 a file system upgrade stored in one of the plurality of reserved memory partitions is provided. Code download images are usually monolithic, i.e., there are usually multiple pieces of code that are all contained in one code image. When the KA stack is downloaded, the Linux kernel and all the libraries that make up the KA stack are included. The memory manager, e.g., dm-verity, allows the kernel to be loaded first. Then all of the libraries can be mounted as a root disk. Being able to separate those two pieces (the kernel and the root disk) provides the ability to reduce the size of the reserved areas for code download. The reserved memory areas/partitions are referred to within this disclosure and in the drawings as ping and pong or KERN_1 and KERN_2. Using the techniques described in the present disclosure, the reserved areas are not required to be sized to handle a large monolithic software image any longer. The reserved areas can now be sized to handle the kernel instead of the monolithic image. The kernel size is significantly smaller.

At block 315, the partition sizes of the plurality of reserved memory partitions and the file system partition are changed in response to the provided file system upgrade. Changing partition sizes of the memory partitions may include increasing and/or decreasing the sizes of each memory partition. For example in a system having ping and pong sized at 64 MB each, the size of ping and pong can be reduced to about 8 MB each since the kernel being stored is only around 5-6 MB. Adding the dm-verity feature on the KA stack, provides the ability to code download the kernel to the STB. The STB can then pull down the root disk without having to write the root disk to the ping and pong areas. Instead, the STB writes the root disk directly to the flash file system. In other words, enough of the code is downloaded and running, i.e., the kernel, to download the rest of the code, i.e., the root disk. The present disclosure provides the ability to add enough features to the kernel to be able to code download the rest of the code, which is the root disk. After the kernel is installed and after the STB is rebooted and the new kernel is present, the rest of the code, e.g., the root disk, can now be downloaded once network connectivity is established.

The KA stack uses an Ethernet connection rather than an out of band quadrature amplitude modulation (QAM) channel. The Ethernet connection may be an unreliable connection. As such, the information necessary for the upgrade to proceed is stored in the very flash that is targeted for repartitioning using the techniques of the present disclosure.

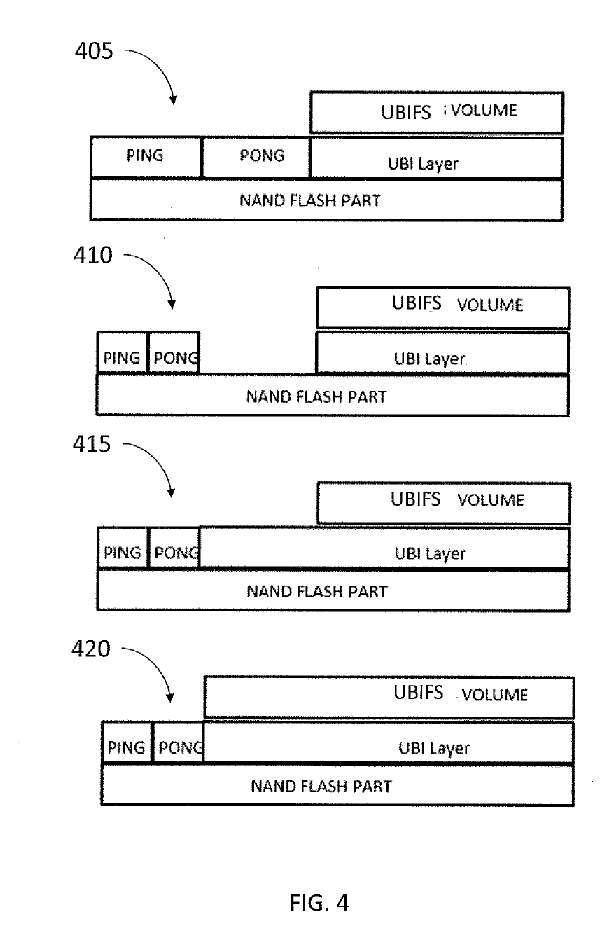

FIG. 4 illustrates an example of a progression of a software stack migration. Element 405 shows an example of a beginning NAND flash partition layout.

Element 410, shows an example of a new partition layout upon boot-up of the kernel of the new file system. The boot-up script detects that the UBI layer is not optimally sized. The UBIFS layer is scanned to determine an actual size of the volume under the old file system. The size difference between the new partition and the old UBIFS volume is calculated and the flash erased.

Element 415 shows the UBI layer expanding into the newly detected memory without error. Element 420 shows that the UBIFS volume is now resized. The UBIFS volume can be resized using a Linux volume change command.

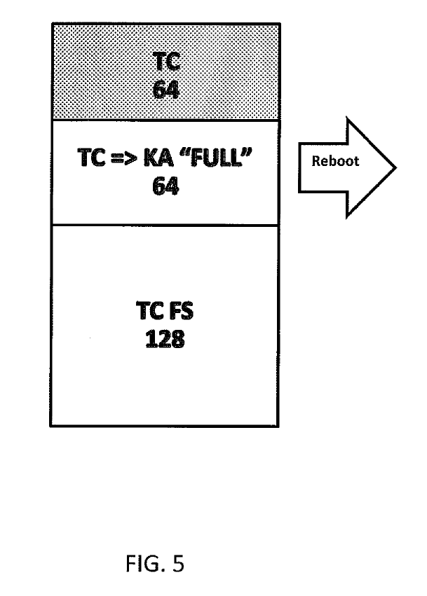

FIGS. 5-8 illustrate an example of a progression of a software stack migration. More particularly, in this example, FIGS. 5-8 illustrate a method for upgrading from thin client to a KA stack. Although the present example is directed to a migration from thin client to KA, it should be noted that the methods disclosed herein can be applied to any software migration. FIGS. 5-8 show three memory partitions/slots: ping (the top layer), pong (the middle layer), and the file system layer (the bottom layer). The patterned slot denotes which slot is active at any given time during the upgrade. During the upgrade, the ping and pong partitions are reduced. Normally after a code download occurs on a STB running thin client, the ping and pong partitions become unused memory space, at least one of which hold good images of the current code. The ping and pong space is not used during normal operation, so if this unused memory space can be reduced (as disclosed herein with the help of the dm-verity memory manager), some of the “dead” space can be reclaimed to be used in the UBIFS.

FIG. 5 illustrates a file system diagram in accordance with implementations of various techniques described herein. The present memory slot size for ping and pong in this example is 64 MB each. In this example, the STB has a total memory of 256 MB. This 256 MB represents the flash memory that is on the STB. Half of the memory (128 MB) is being used for ping and pong and the other half (128 MB) includes the current flash file system. In this example, a thin client (TC) file system is shown.

In the STB, 128 MB is set aside for ping and pong for upgrades in this scheme. In order to be power safe, the upgrades are made to either ping or pong. In this example, new code is downloaded to pong. The new code includes the KA stack. The word “full” denotes that the monolithic code, e.g., the kernel and the root disk, has been downloaded to pong. While the KA stack is being downloaded to the pong space, the ping partition retains the code image for the previous platform stack which, in this case, is thin client. If there is a power interruption, the STB would safely reboot to the ping location because, although the new KA stack is being downloaded to pong, the STB has not yet switched over to the new slot and upgraded. The present method of upgrading the software stack is, thus, power safe because the “good” or presently installed software image is never corrupted.

As stated above, the STB was running thin client, which is the stack presently fielded on the STB and the file system software is being upgraded to a new system stack, KA. While the STB is running, KA is downloaded into the pong location. Once the KA stack is finished downloading, the STB reboots.

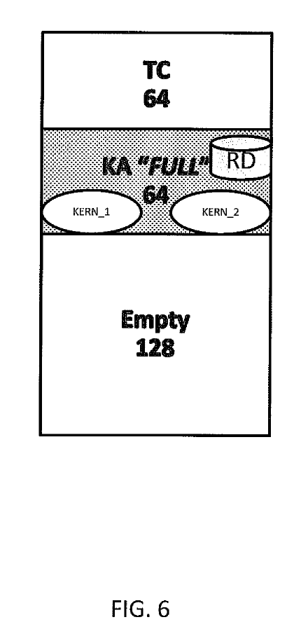

FIG. 6 illustrates a file system diagram in accordance with implementations of various techniques described herein. The STB boots up, using the pong location. The STB loads the new kernel and is now running KA instead of thin client.

Now that the file system has been upgraded from thin client to KA, e.g., from one file system having certain memory requirements to a file system that requires much less memory for software upgrades, the space for ping and pong can be reduced. Instead of one monolithic code image, the downloaded KA stack includes two pieces: the kernel (including KERN_1 and KERN_2) and a root disk, RD. The kernel includes a different partitioning layout. The layout determines how the KA file system interprets the memory that is in the flash portion of the STB. In this example, there are two kernels, KERN_1 and KERN_2, included with the KA stack.

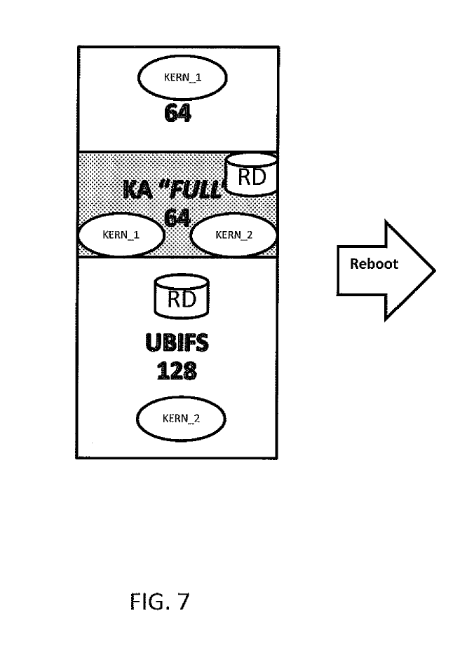

FIG. 7 illustrates a file system diagram in accordance with implementations of various techniques. FIG. 7 describes what occurs when the STB boots up with the KA stack as described above in FIG. 6. The STB boots with the KA stack from the pong location. The kernel, once it boots, creates and mounts the UBIFS, in the 128 MB partition. Now the kernel has the ability to write to a file system, e.g., UBIFS. This file system is the previous file system as it existed under thin client. Because the size of the file system has not yet been changed, the file system is still capable of being mounted normally.

The kernel now copies KERN_2, which is the kernel associated with the new partition layout, into the flash file system. The kernel also copies the root disk (which is also a large file) into the UBIFS. The kernel installs root disk from the UBIFS. Once this occurs, the KA stack is now installed and running. The kernel mounts, e.g. begins to use the data within the root disk, the root disk in the UBIFS. The kernel then installs KERN_1 into the ping location (e.g., the non-active slot) to prepare for the partition size change.

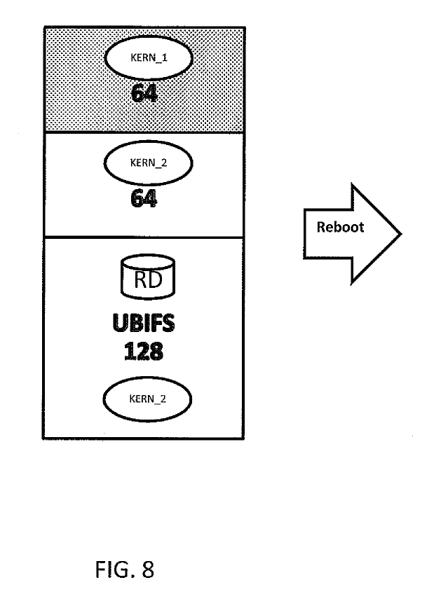

FIG. 8 illustrates a file system diagram in accordance with implementations of various techniques. In FIG. 8, it can be seen that the flash memory still has the same layout partition sizes. In this example, ping still has 64 MB, pong still has 64 MB and the UBIFS still has 128 MB. However, the size of KERN_1 and KERN_2 are only about 5-6 MB. As such, the memory in ping and pong are not being utilized fully. The kernel, KERN_1 boots up from the active slot, which in this example, is the ping location. The kernel, KERN_1, then mounts the root disk that was written into the UBIFS flash file system in FIG. 7. When the kernel, KERN_1 mounts the root disk, the complete KA stack is running. The KA stack then installs KERN_2, which was previously written into the UBIFS, into the pong location. The kernel, KERN_2, includes a new partition layout for flash. The new partition layout includes 16 MB for ping, 16 MB for pong and 224 MB for the UBIFS. Although in this example, ping and pong are configured to be 16 MB, these partitions can be sized to be at least 8 MB or any suitable partition size less than 64 MB.

Kernel, KERN_2, includes the information for reformatting to the different slot sizes. Kernel, KERN_2, has the layout and when KERN_2 boots up, this kernel is configured, in this example, for partition sizes 16 (ping)/16(pong)/224(UBIFS), which is very different from what is presently stored in the disk of the flash.

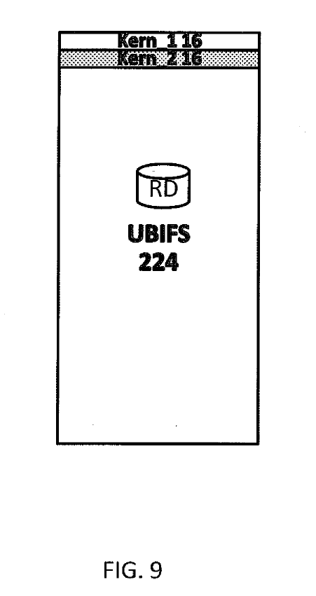

FIG. 9 illustrates a file system diagram in accordance with implementations of various techniques. Once KERN_2 is installed as described above, the partitions are then reformatted as shown in FIG. 9. The kernel, KERN_2, includes a new partition size table that determines the sizes of the partitions in the flash memory. The kernel, KERN_2, boots up with the old partition size table first (having the 64 MB, 64 MB, 128 MB memory partition size configuration). This old partition size table, e.g., partition size table 220, is stored in NOR flash 215. The NOR flash can be used for items that the boot code needs upon boot up. Kernel, KERN_2, provides the new partition size table, which has a different memory partition size configuration, e.g., 16 MB, 16 MB, and 224 MB, and writes the new partition size table to the boot code included in the NOR flash by overwriting the old (current) table with the new table.

In FIG. 9, boot up occurs from the pong location. Because the NOR now includes the new table, boot up occurs with the new partition configuration where ping and pong each have a partition size of 16 MB. At this point, the UBIFS is still sitting in the partition having 128 MB. Above the UBIFS, there is free space that has been created by shrinking the ping and pong location. The amount of available memory available for the UBIFS partition is now larger, however, further action from the kernel is called for in order to properly access this newly available memory.

As described below, the new space provided by the reduction of the size of the ping and pong partitions may be included: with destruction and without destruction. In one implementation, the kernel can simply mount the UBIFS. In this implementation, the kernel erases the entire flash memory and subsequently boots up with the new partition sizes. In another implementation, prior to mounting the UBIFS, the data in the newly freed space is erased and the UBIFS is mounted without losing the existing data.

In the implementation with destruction, the kernel mounts the UBIFS using the new table that configures the UBIFS partition size to be 224 MB. Since the UBIFS remains in the 128 MB partition, the system will crash because the free space from the former ping and pong partition would not appear to be part of the UBI layer. The kernel would then erase the entire partition and start over with the newly configured partition sizes upon a subsequent boot up of the STB.

In the implementation without destruction, the newly freed memory is added to the existing UBIFS without destruction, i.e., without erasing the entire partition and starting over. In this implementation, prior to mounting the UBIFS, the new partition is scanned for a super node within the UBIFS. The super node is a master node of the flash file system that provides information about what the file system was created as. At least a portion of the information provided by the super node is size information. With respect to size information, there are two concerns related to size information. The first concern was discussed above with respect to the volume layer, which provides the size of the old file system. The second concern is related to the super node. The super node provides the size of the new file system. When the partition boots up, the boot up script determines that there is a difference in the size of the UBI layer by comparing the size information provided by the super node and making a determination that the file system has grown. First, the space is freed by determining a difference between the volume layer and the new partition sizes. Once the free space is determined, that space is erased. After the space is erased, the file system boots up again. The super node determines that there is extra space and provides an acknowledgement of that extra space in the super node. Two layers are expanded in this software stack migration, first the UBI layer is expanded and then the super node is used to expand the UBI-FS layer.

The flash system was originally created as a 128 MB flash file system, however, as provided by the new table, the partition size of the UBIFS is now 224 MB. The kernel is configured to calculate the difference between the original partition size of the UBIFS and the new partition size of the UBIFS. In this example, this calculation provides a difference of about 96 MB of newly freed space. The kernel, upon determining the amount of newly freed space erases only the 96 MB of free space, i.e., the new flash area newly freed up from the ping and pong areas. Now, when the UBI layer is mounted by the kernel, the kernel sees the new memory that has been added and the existing UBI layer already intact below. The kernel will now expand the UBI layer to include all of the additional new memory space without destroying the existing data that was already stored in the previous 128 MB section. In order to expand the UBI layer and mount this layer with the full 224 MB space, the kernel executes a volume change command that expands the flash file system to include the newly acquired UBI layer.

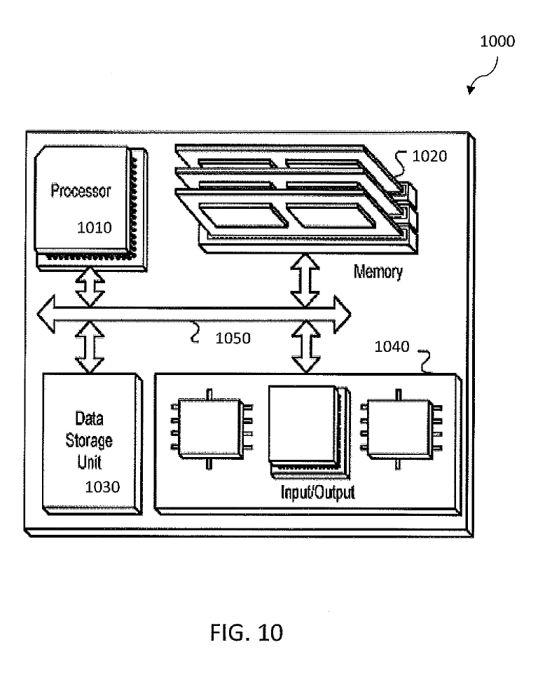

FIG. 10 is a block diagram of a hardware configuration 1000 operable to provide a software stack migration. The hardware configuration 1000 can include a processor 1010, a memory 1020, a storage device 1030, and an input/output device 1040. Each of the components 1010, 1020, 1030, and 1040 can, for example, be interconnected using a system bus 1050. The processor 1010 can be capable of processing instructions for execution within the hardware configuration 1000. In one implementation, the processor 1010 can be a single-threaded processor. In another implementation, the processor 1010 can be a multi-threaded processor. The processor 1010 can be capable of processing instructions stored in the memory 1020 or on the storage device 1030.

The memory 1020 can store information within the hardware configuration 1000. In one implementation, the memory 1020 can be a computer-readable medium. In one implementation, the memory 1020 can be a volatile memory unit. In another implementation, the memory 1020 can be a non-volatile memory unit.

In some implementations, the storage device 1030 can be capable of providing mass storage for the hardware configuration 1000. In one implementation, the storage device 1030 can be a computer-readable medium. In various different implementations, the storage device 1030 can, for example, include a hard disk device/drive, an optical disk device, flash memory or some other large capacity storage device. In other implementations, the storage device 1030 can be a device external to the hardware configuration 1000.

The input/output device 1040 provides input/output operations for the hardware configuration 1000. In one implementation, the input/output device 1040 can include one or more of a network interface device (e.g., an Ethernet card), a serial communication device (e.g., an RS-232 port), one or more universal serial bus (USB) interfaces (e.g., a USB 2.0 port), one or more wireless interface devices (e.g., an 802.11 card), and/or one or more interfaces for outputting video, voice, and/or data services to a display device (e.g., television 110 of FIG. 1, mobile device, tablet, computer, etc.). In embodiments, the input/output device can include driver devices configured to send communications to, and receive communications from one or more networks (e.g., local network, subscriber network 120 of FIG. 1, WAN 115 of FIG. 1, etc.).

The subject matter of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

The discussion above is directed to certain specific implementations. It is to be understood that the discussion above is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions may be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

In the above detailed description, numerous specific details were set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and downwardly”; “below” and “above”; and other similar terms indicating relative positions above or below a given point or element may be used in connection with some implementations of various technologies described herein.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
providing a flash memory including a plurality of memory partitions, the plurality of memory partitions comprising at least two reserved memory partitions and a file system partition;
providing a file system upgrade stored in one of the plurality of reserved memory partitions; and
changing partition sizes of the plurality of reserved memory partitions and the file system partition in response to the provided file system upgrade.

2. The method of claim 1 wherein the flash memory comprises a NAND flash.

3. The method of claim 1, wherein the file system partition comprises an unsorted block images (UBI) layer partition.

4. The method of claim 3, wherein a boot-up script detects whether the UBI layer partition is optimally sized.

5. The method of claim 4, wherein the UBI layer partition is expanded into newly detected memory using a volume change command.

6. The method of claim 1, wherein the file system upgrade is power safe.

7. The method of claim 6, wherein one of the at least two reserved memory partitions includes a code image of a previous file system.

8. The method of claim 7, wherein the code image of the previous file system is booted to when a power interruption occurs.

9. The method of claim 1, wherein the provided file system upgrade includes a kernel and a root disk.

10. The method of claim 9, wherein the kernel includes a partitioning layout.

11. The method of claim 10, wherein the partitioning layout is included in a partition size table.

12. The method of claim 11, wherein the partition sizes are changed in accordance with the partition size table.

13. The method of claim 1, wherein the partition sizes are changed with destruction or without destruction.

14. The method of claim 13, wherein the partition sizes are changed with destruction by erasing the flash memory and booting up with the changed partition sizes.

15. The method of claim 13, wherein the partition sizes are changed without destruction by erasing free space provided by the file system upgrade.

16. The method of claim 15, wherein the free space is determined by determining a difference between the changed file system partition size and an original file system partition size.

17. The method of claim 15, wherein the free space is added to the file system partition from the at least two reserved memory partitions.

18. The method of claim 15, wherein the file system partition is expanded to include additional memory space without destroying existing data already stored in the file system partition.

19. A device, comprising:
a set top box configured to:
provide a flash memory including a plurality of memory partitions, the plurality of memory partitions comprising at least two reserved memory partitions and a file system partition;
provide a file system upgrade stored in one of the plurality of reserved memory partitions; and
change partition sizes of the plurality of reserved memory partitions and the file system partition in response to the provided file system upgrade.

20. A non-transitory computer-readable medium having stored thereon a plurality of computer-executable instructions which, when executed by a computer, cause the computer to:
provide a flash memory including a plurality of memory partitions, the plurality of memory partitions comprising at least two reserved memory partitions and a file system partition;
provide a file system upgrade stored in one of the plurality of reserved memory partitions; and
change partition sizes of the plurality of reserved memory partitions and the file system partition in response to the provided file system upgrade.
